(19) United States
(12) Patent Application Publication
(10) Pub. No.: US 2010/0088122 A1
(43) Pub. Date: Apr. 8, 2010

(54) LIFE INSURANCE SYSTEM AND METHOD

(76) Inventors: Wiiliam Gray, Minneapolis, MN (US); Gary J. Lenahan, Laguna Hills, CA (US); Lionel D. Kolker, San Diego, CA (US)

Correspondence Address: DICKE, BILLIG & CZAJA, FIFTH STREET TOWERS, 100 SOUTH FIFTH STREET, SUITE 2250, MINNEAPOLIS, MN, 55402, US

(21) Appl. No.: 11/936,027

(22) Filed: Nov. 6, 2007

Related U.S. Application Data
(60) Provisional application No. 60/864,482, filed on Nov. 6, 2006.

(51) Int. Cl. G06Q 40/00

(52) U.S. Cl. 705/4; 705/35; 705/38

(57) ABSTRACT

A system for providing life insurance with no out-of-pocket cost including life insurance premiums, a cash component, an increasing death benefit having a fixed portion and a rider portion, the rider portion being at least equal to a cumulative loan balance, an investment configured to provide a rate of return for the cash component, and a stock loan using stock collateral which configured to pay the life insurance premiums.

### CROSS-REFERENCE TO RELATED APPLICATIONS

The subject matter of this application is related to the subject matter of U.S. Provisional Patent Application No. 60/864,482, filed on Nov. 6, 2006, priority to which is claimed under 35 U.S.C. §119(e) and which is incorporated herein by reference.

### BACKGROUND

Where a high net worth individual has the liquidity need to fund legacies for heirs or to avoid the perils of untimely liquidation of an Estate at death, life insurance is often the preferred tool. Life insurance generally renders the most convenient and tax-advantaged result for liquidity purposes due its essential properties of at least providing: (1) an immediate tax-free death benefit in excess of premiums paid; (2) non-taxed compounding of cash values; and (3) tax-free accessibility of cash values.

Life insurance is typically purchased with after-tax funds. However, for high network individuals who obtain life insurance on a personal level for a trust, with annual premiums being gifted to the trust, purchasing conventionally with after-tax funds is generally a losing investment. In such a scenario, the funds to cover annual premiums are taxed twice, first via the individual's income tax (e.g. 35%) and then via the gift tax (i.e. 40%). Taking into account an “opportunity cost” associated with foregoing investment of the pre-tax value of the funds (e.g. 7.5%), the “actual” or “true” cost of the life insurance policy to the individual invariably exceeds the death benefit of the policy, often before the individual reaches his/her predicted life expectancy. This often holds true even when the gift tax is removed from the equation.

For these and other reasons, there is a need for embodiments described herein.

### SUMMARY

One embodiment describes a system for providing life insurance with no out-of-pocket cost. The system includes life insurance premiums, a cash component, an increasing death benefit having a fixed portion and a rider portion, the rider portion being at least equal to a cumulative loan balance. The system further includes an investment configured to provide a rate of return for the cash component, and a stock loan using stock collateral configured to pay the life insurance premiums.

### BRIEF DESCRIPTION OF THE DRAWINGS

FIG. 1 is a block diagram illustrating one embodiment of a system for providing life insurance.

FIG. 2 is a table illustrating an example embodiment of the system of FIG. 1.

FIG. 3 is a table illustrating an example embodiment of the system of FIG. 1.

FIG. 4 is a table illustrating collateral requirements of an example embodiment.

FIG. 5 is a diagram illustrating one embodiment of a stock loan.

FIG. 6 is a diagram illustrating one embodiment of a stock loan.

FIG. 7 is a diagram illustrating one embodiment of a stock loan.

FIG. 8 is an illustrative example of a stock loan quote according to one embodiment.

### DETAILED DESCRIPTION

In the following Detailed Description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

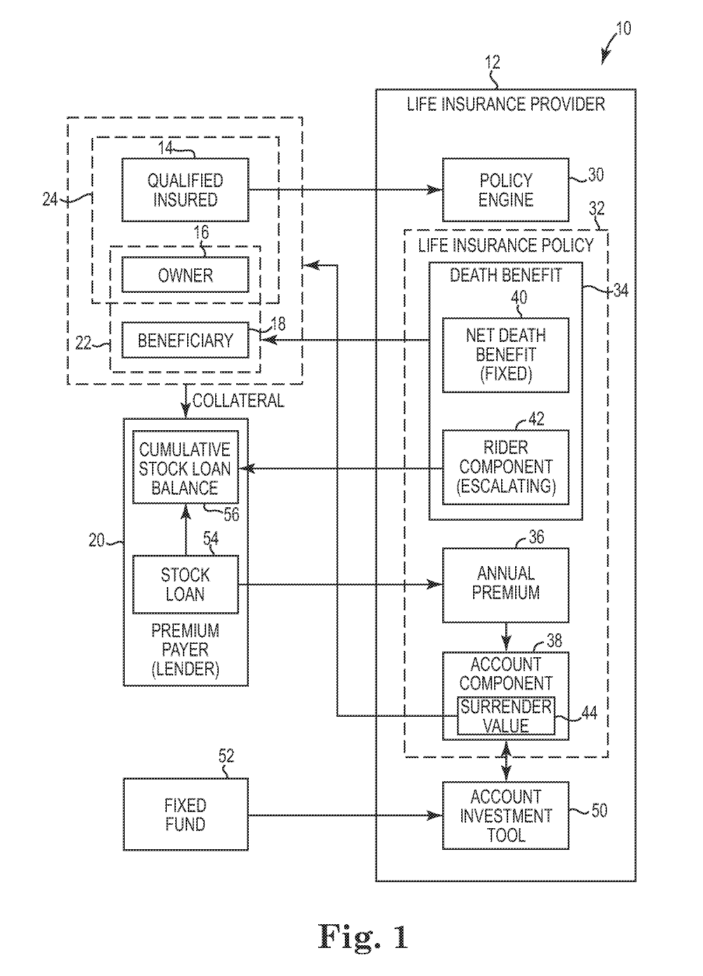

FIG. 1 is a block diagram generally illustrating one embodiment of a system 10 for providing the pre-tax purchase of a life insurance policy based on a qualifying individual with no present out-of-pocket expense to an owner of the policy, the policy employing an investment tool to maintain a cash value of the policy.

The system provides the pre-tax purchase of insurance with premiums paid by a stock loan. The life insurance system and method is designed to cover its own financing costs. In one embodiment, system 10 includes a life insurance provider 12, a qualified insured 14, a policy owner 16, a beneficiary 18, and a premium payor/lender 20. In one embodiment, the owner 16 and beneficiary 18 are each part of a common entity 22, such as an insurance trust associated with the qualified insured 14. In one embodiment, the qualified insured 14 and the owner 16 are one and the same, as indicated at 24.

In one embodiment, life insurance provider 12 includes a policy engine 30 which receives data representative of the qualified insured 14, such as the age and asset values of the qualified insured 14, for example, and based on the data, generates a life insurance contract 32 including a death benefit 34, an annual premium 36, and an account or cash component 38. Death benefit 34 includes a fixed net death benefit 40 and an escalating rider component 42, and account or cash component 38 includes a surrender value 44. Life insurance provider 12 further includes an account investment tool 50 in which account component 38 is invested, the account investment tool 50 providing a rate of return on account component 38. In one embodiment, account investment tool 50 provides a fixed rate of return by investing account component 38 in a fund 52 providing a fixed rate of return. Surrender value 44 comprises a portion of account component 38 which is paid to owner 16 if the life insurance policy is terminated prior to the death of qualified insured 14.

According to one embodiment, premium payor/lender 20 finances the annual premiums of the life insurance policy for at least a portion of a life of the policy via a series of loans 54, each at an interest rate, with the loans together having a cumulative loan balance 56. In one embodiment, premium payor/lender 20 comprises a financial institution. In return for financing the annual premiums, the premium payor/lender 20 stock receives collateral from owner 16 which, as described above may also include the qualified insured 14. Net death benefit 40 remains fixed for a life of the insurance policy and is paid to beneficiary 18 upon death of the qualified insured 14. Rider component 42 escalates over the life of the insurance policy so as to be equal to cumulative loan balance 56 and is paid to premium payor/lender 20 upon death of qualified insured 14.

By financing the premiums of the life insurance policy 32 via loans 54 from a premium payor or lender 20 and paying off the cumulative loan balance 56 via an escalating rider component 42, the owner 16 (e.g. the qualified insured 14, life insurance trust 22) is able to provide a fixed net death benefit 40 to a beneficiary 18 (e.g. life insurance trust 22) with no current out-of-pocket outlay. Additionally, as will be described in greater detail below, by employing account investment tool 5 to provide a rate of return on the cash value or account component 38 based on one or more financial indices 52, life insurance provider 12 is able to better grow and maintain a positive value of account component 38 and thereby longer sustain life insurance policy 32 relative to conventional techniques.

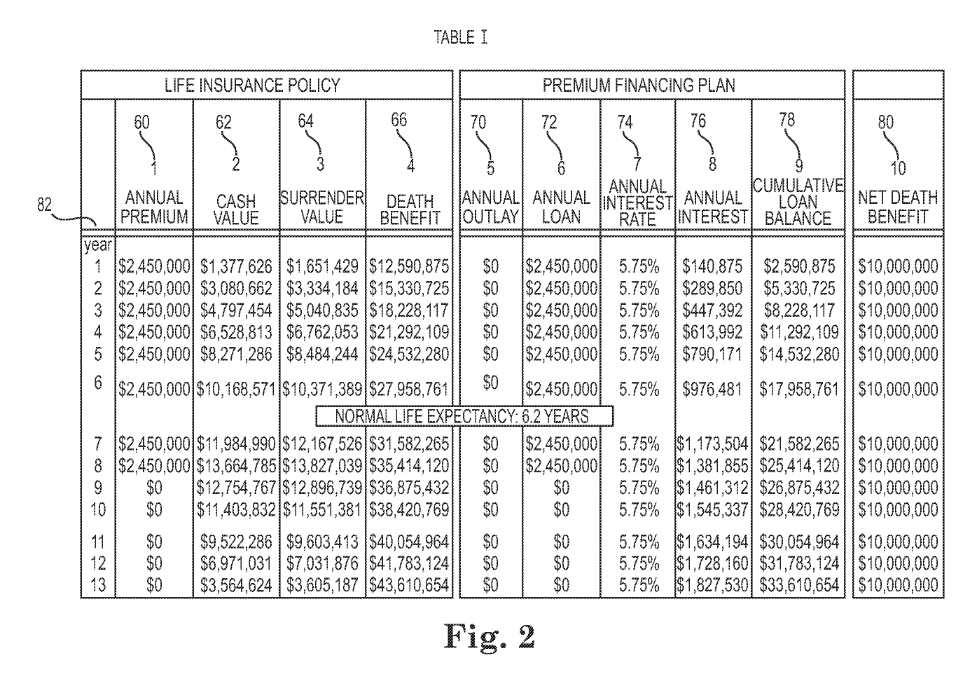

FIG. 2 is a Table I illustrating an example embodiment of a life insurance policy 32 offered by life insurance provider 12 according to system 10 of FIG. 1. Table I includes ten columns. Columns 1-4, as respectively indicated at 60, 62, 64, and 66, describe the example embodiment of life insurance policy 32, while columns 5-9, as respectively indicated at 70, 72, 74, 76, and 78, describe a premium financing plan to fund the annual premium 36 of life insurance policy 32. Column 10,at 80, describes net death benefit 40 provided by life insurance policy 32. The year of operation of life insurance policy 32 is illustrated along the left-hand side of Table I, as indicated at 82. In the example of Table I, it is noted that the operation of life insurance policy 32 is illustrated for 15 years, with qualified insured 14 having a normal or predicted life expectancy of 6.2 years from commencement of life insurance policy 32.

Column “1”, at 60, indicates the annual premium 36 of life insurance policy 32, with the example of Table I having an annual premium 36 of $2,450,000. Column “2”, at 62, indicates a surrender component or surrender value 44 life insurance policy 32, which is paid to owner 16 should life insurance policy 32 be terminated before the death of the qualified insured 14. Column “3”, at 66, indicates account component or account value 38. Each year annual premium 36 is paid, a portion (e.g. the annual premium amount minus costs, fees, commissions, etc.) is paid to account component 38, which is invested via account investment tool 50. As mentioned above, in one embodiment, account component 38, as indicated by column “3”, is invested via account investment tool 50 which provided a fixed rate of return. In the embodiment of Table I, it is noted that account investment tool 50 provides a fixed rate of return of 5.4%.

According to one embodiment, annual premium 36 is paid each year until account component 38 grows to an amount such that annual premium 36 can be funded from account component 38 for an expecting remaining life of life insurance policy 32. In the example of Table I, account component 38 is illustrated as maintaining annual premium 36 and costs associated with maintenance of life insurance policy 32 by life insurance provider 12 for seven years after payment of a last payment of annual premium 36 via premium payor/lender 20. It is noted that surrender value 44 of column “2” is based on a value of account component 38 of column “3” such as, for example, the value of account component 38 of column “3” minus a penalty for early termination of life insurance policy 32.

Column “4”, at 66, indicates death benefit 34 to be paid by life insurance policy 32 to beneficiary 18 upon the death of the qualified insured 14. As described above, death benefit 34 includes net death benefit 40, which is a fixed amount, as indicated by column “10”, and rider component 42 which increases or escalates each year of the life of the life insurance policy so as to be equal the cumulative loan balance 56 of the premium financing plan provided by premium payor/lender 20. In the example of Table I, net death benefit 40, with reference to column “10” at 80, is equal to $10,000,000.

As mentioned above, columns 5-9 describe the premium financing plan employed to fund annual premium 36 of life insurance policy 32. Column “6”, as indicated at 72, indicates an amount of annual stock loan 54 provided by premium payor/lender 20 to life insurance provider 12 to pay annual premium 36. As such, annual stock loan 54 of column “6” is equal to annual premium 36 of column “1”. As will be described in greater detail below, in order to obtain annual stock loans 54 of the premium financing plan, owner 16 of life insurance policy 32 provides collateral on an on-going basis.

According to one embodiment, annual premium 36 is funded via the premium financing plan until account component 38 of column “3” has a value sufficient to fund annual premium 36 for an expected remaining life of life insurance policy 32. In the example of Table I, annual premium 36 is funded via the premium financing plan for the first 8 years. Column “5”, as indicated at 70, illustrates the annual “out-of-pocket” outlay by owner 16 (who may or may not be the qualified insured 14), which is zero for the life of the life insurance policy 32 (i.e. “zero outlay”).

Column “7”, as indicated at 74, illustrates the annual interest rate of annual stock loans 54 provided as part of the premium financing plan by premium payor/lender 20. In the example of Table I, the annual interest rate is 5.75%. Column “8”, as indicated at 76, illustrates the annual interest accrued on annual stock loans 54 of column “6” and on cumulative stock loan balance 56, which is illustrated by column “9”, as indicated at 78.

Column “10” indicates net death benefit 40 paid to beneficiary 18 of life insurance policy 32 (e.g. an heir, a life insurance trust fund) upon death of qualified insured 14. As described above, net death benefit 40 of column “10” is a fixed component of death benefit 34 provided by life insurance policy 32, as indicated by column “4”, while rider component 42 is an escalating component which is adjusted so as to be equal to cumulative stock loan balance 56 of column “9”. As such, in any given year during the life of life insurance policy 32, the sum of net death benefit 40 of column “10” and cumulative stock loan balance 56 of column “9” is equal to death benefit 40 of column “4”.

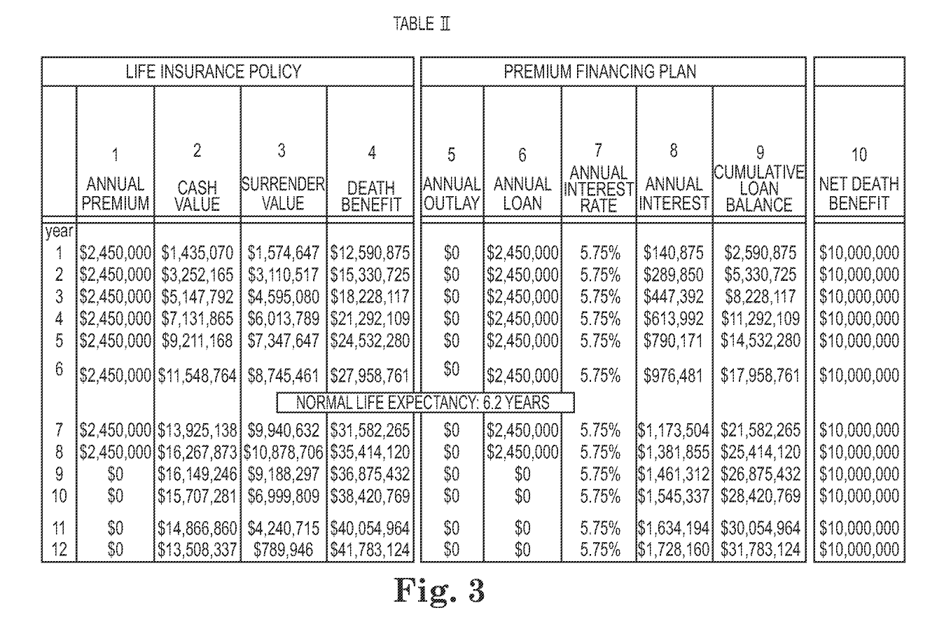

According to one embodiment, account investment tool 50 provides a variable rate of return, such as by investing in a stock fund, for example, while providing a guaranteed minimum rate of return. In one embodiment, the guaranteed minimum rate of return is 1%. FIG. 3 is a Table II illustrating the example embodiment of Table I assuming that the rate of return provided by investment tool 50 is the guaranteed minimum rate of 1% for the life of life insurance policy 32.

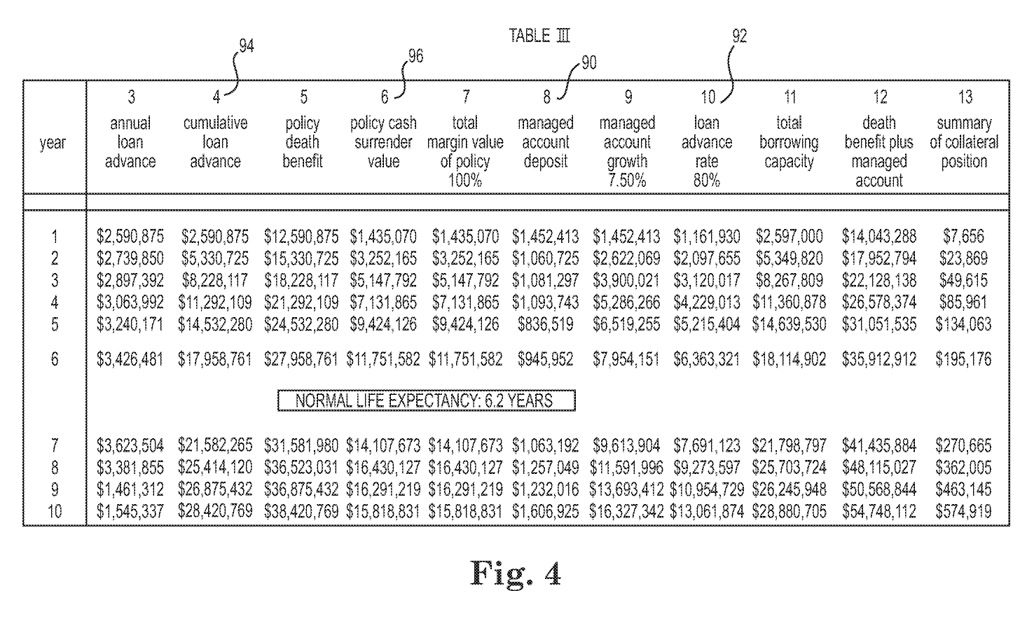

FIG. 4 is a Table III illustrating the on-going collateral required for an example embodiment. The on-going collateral pledges or deposits are illustrated by “Managed Account Deposit” of column “8”, as indicated at 100. In some embodiments, premium payor/lender 20 accepts only 80% of the value of the pledged collateral, as illustrated by the “Loan Advance Rate” of column “10”, as indicated at 102. As such, the “Loan Advance Rate” of column “10” must at least be equal to the difference in value between the cumulative loan balance 56 and the surrender value 44, as respectively illustrated by columns “4” and “6” at 104 and 106.

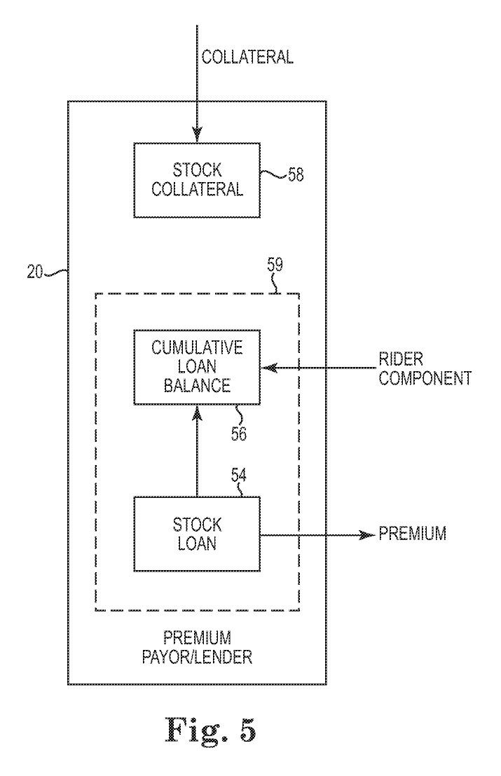

In one embodiment illustrated in FIG. 5, stock loan 54 is provided by the premium payor/lender for payment of premiums 36 associated with the life insurance policy 32. The stock loan 54 is based on stock collateral 58 provided by the owner. The stock loan 54 is configured to have a high value relative to a high percentage of a value of the stock collateral 58. In one embodiment, the stock loan 54 is over 75% of the value of the stock collateral 58.

The stock loan 54 provides for premium financing based on stock portfolio sizes that are relatively small (e.g., $500,000). The stock loan 54 is secured by both the stock collateral 58 and the insurance policy rider component 42. The rider component 42 increases the death benefit 34 by both the amount of premium 36 and interest accrued from the stock loan 54.

In one embodiment, stock loan 54 and cumulative loan balance 56 are replaced by a stock holding account, as indicated by the dashed lines at 59. A lump sum stock loan is deposited or held in stock holding account 59, the loan being of sufficient value to cover annual premiums 36 for the life of life insurance policy 32, with stock holding account 59 earning interest on the lump sum stock loan. Payments of annual premiums 36 using the stock loan are made directly from stock holding account 59.

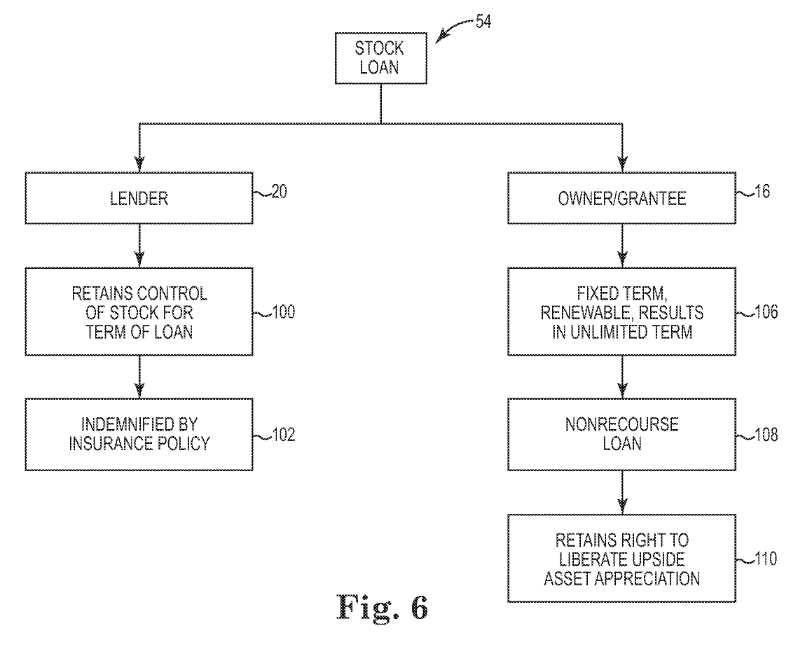

FIG. 6 illustrates one embodiment of stock loan 54 having a premium payor/lender 20 and an owner 16. The premium payor/lender 20 may include a financial institution (e.g., a bank), or other financial entity such as a private financial firm. The premium payor/lender 20 generates the stock loan 54. As described above, the owner 16 may include the qualified insured 14 or a life insurance trust. The owner 16 provides the stock collateral 58 for the stock loan 54.

The stock loan 54 is based on a portfolio of stock collateral of sufficient size to fund the insurance policy 32. The stock loan 54 generates cash at a fixed rate which is sufficient to fund premiums 36 of insurance policy 32. In one embodiment, interest on the stock loan 54 is accrued without compounding.

At 100, the premium payor/lender 20 retains control of the stock collateral 58 for the term of the loan 54. In one embodiment, the premium payor/lender 20 has a right to sell all or a portion of the stock collateral 58 at any time during the term of the loan 54. In one embodiment, the premium payor/lender 20 controls the stock for the term of the loan 54, including putting a ceiling on appreciation of the stock collateral 58. In one example embodiment, the premium payor/lender 20 has a 150% ceiling on appreciation of the value of the stock collateral 58. Any appreciation of the stock collateral 58 value over 150% goes to the premium payor/lender 20, and as such that portion of the stock collateral 58 (over 150%) is redeemable by the premium payor/lender 20.

At 102, the premium payor/lender 20 is indemnified by the insurance policy 32. The insurance policy 32 acts to indemnify the premium payor/lender 20 against loss of principal and interest associated with a decrease in value of stock collateral 58 through the increase in death benefit 34. The premium payor/lender 20 is indemnified on an annual basis for the life of the qualified insured 14. In one embodiment, the rider component 42 of the increasing death benefit 34 is at least equal to the cumulative stock loan balance 56 associated with the stock loans 54. The increased death benefit of the rider component 42 is pledged as payment to the premium payor/lender 20.

At 106, the stock loan 54 has an effective unlimited term. In one embodiment the stock loan 54 provides for payment of the premiums 36, at a fixed rate for a fixed term.

The stock loan 54 is renewable at the end of the term. The stock loan 54 includes a cumulative loan value 56 that accrues at an interest rate without compounding. In one embodiment, the stock loan 54 is renewable for the same loan terms (i.e., fixed rate, fixed term) as the previous stock loan. This has the effect of a stock loan for an unlimited term until the happening of a triggering event, such as death of the qualified insured 14 or sale of the life insurance policy 32.

At 108, the stock loan 54 operates as a non-recourse loan to the owner 16. As such, if the stock collateral 58 should drop in value, the stock loan 54 is non-callable and the premium payor/lender 20 has no recourse against the owner 16.

At 110, the owner 16 retains the right to liberate upside asset appreciation. The asset appreciation can be liberated from the stock collateral 58 during the term of the loan 54, prior maturity or redemption of the stock shares. The owner 16 receives the excess appreciation of the stock collateral 58, and the stock loan 54 is renewable without the excess stock amount or value needed to back the stock loan 54.

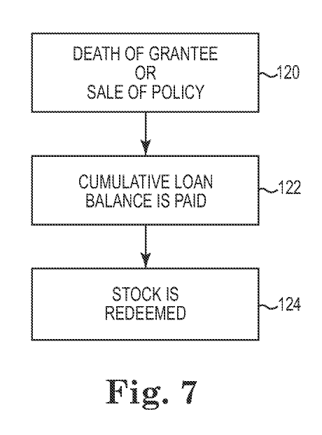

FIG. 7, as indicated at 120, illustrates one embodiment of the operation of the stock loan 54 upon death of the qualified insured 14 or sale of the life insurance policy 32. At 122, the cumulative loan balance 56 is paid by the death benefit 34 of the life insurance policy 32. In one embodiment, the rider component 42 is equal to the cumulative loan balance 56 and is paid to the premium payor/lender 20. At 124, the stock collateral 58 is redeemed.

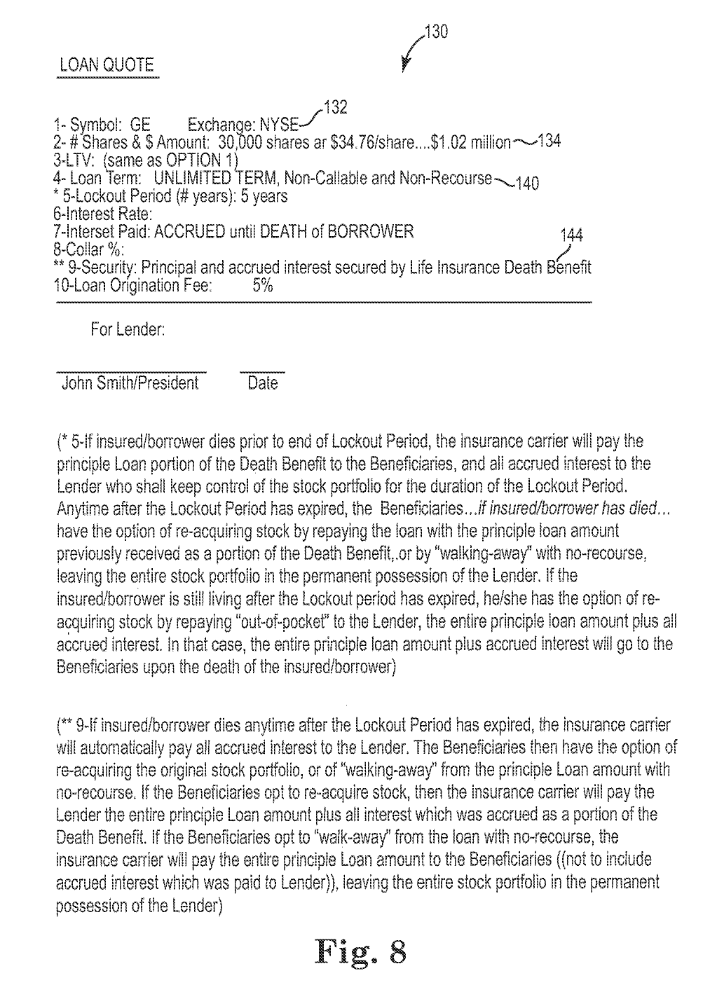

FIG. 8 illustrates one example of a loan quote 130 indicating loan terms associated with one embodiment of a stock loan 54 using stock collateral 58 configured to pay life insurance premiums 36. The loan quote 130 is based on a General Electric Company (GE) stock GE on a public stock exchange 132. The number of shares and share amount 134 result in a stock value used in achieving the stock loan amount 136. Further, the loan quote 130 has an unlimited term, is non-callable and non-recourse, indicated at 140. The loan quote 130 indicates a lockout period of 5 years. The loan includes a security, including of the principal and accrued interest secured by the life insurance death benefit, indicated at 144.

In summary, the life insurance system provides a life insurance policy with no out-of-pocket expense to the owner. The loan is secured by stock, allowing for a higher percentage of the stock value to be used to determine the stock collateral. The stock loan 54 is non-recourse, non-callable to the owner. The owner retains the right to liberate any upside asset appreciation from the stock collateral during the term of the stock loan. Relatively low value stock portfolios ($100,000 or more) can be used to provide collateral for a stock loan 54 used to pay premiums for the life insurance policy. The loan is secured by both the stock and the insurance policy rider.

Although described herein as being employed to pay annual premiums of a life insurance policy employing an escalating ride component to cover costs of the premium financing plan, it is noted that the use of a stock loan to pay premiums can also be applied to life insurance policies which do not employ such an escalating rider component of the death benefit.

One or more embodiments are employed using software, hardware, or a combination of software and hardware. The software may be employed on one or more computers, or a centralized computing system via a network. In one embodiment, the system is employed on a web-based system via the Internet.

In one embodiment, components of the stock loan 54 and cumulative loan balance are generated and tracked using software run on one or more computers. Further, the components of the policy engine, life insurance policy and account investment tool are also generated, tracked and communicate with each other via software run on one or more computers.

The system and method according to one or more embodiments provides the pre-tax purchase of insurance with premiums paid by a stock loan, and nothing currently out-of-pocket by the insured. The life insurance system and method is designed to cover its own financing costs.

The present invention is employed using software, hardware, or a combination of software and hardware. The software may be employed on one or more computers, or a centralized computing system via a network. In one embodiment, the present invention is employed on a web-based system via the Internet.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A system for providing life insurance with no out-of-pocket cost comprising:
life insurance premiums;
a cash component;
an increasing death benefit having a fixed portion and a rider portion, the rider portion being at least equal to a cumulative loan balance;
an investment configured to provide a rate of return for the cash component; and
a stock loan using stock collateral and configured to pay the life insurance premiums.

2. The system of claim 1, comprising:
wherein the stock collateral comprises one or more stocks owned by an insured associated with the life insurance.

3. The system of claim 1, comprising:
wherein the stock loan is configured to provide principal at an interest rate.

4. The system of claim 1, comprising:
wherein the stock loan is base on 80% or more of a value of the stock collateral.

5. The system of claim 1, comprising:
wherein the stock loan is provided by a lender, where the lender maintains control of the stock for a term of the stock loan.

6. The system of claim 5, comprising:
wherein the control includes a right to sell the stock collateral.

7. The system of claim 1, comprising:
wherein the rider portion is configured to indemnify a lender of the stock loan.

8. The system of claim 1, comprising:
wherein the stock loan is configured as non-recourse to the insured.

9. The system of claim 1, comprising:
wherein the stock loan is non-callable.

10. The system of claim 1, comprising:
wherein the insured retains a right to liberate upside asset appreciation of stock associated with the stock loan.

11. The system of claim 1, comprising:
where the stock loan comprises a fixed term loan having loan terms, renewable at the loan terms.

12. A method for providing life insurance with no out-of-pocket cost comprising:
defining a life insurance policy having life insurance premiums, a cost component, and an increasing death benefit having a fixed portion and a rider portion, the rider portion being at least equal to a cumulative loan balance;
increasing the cash component using an investment; and
using stock collateral for a stock loan, configured to pay the life insurance premiums.

13. The method of claim 12, comprising:
basing the stock loan on 80% or more of a value of the stock collateral.

14. The method of claim 12, comprising:
maintaining control of the stock for a term of the stock loan by a lender, including a right to sell the stock collateral.

15. The method of claim 12, comprising:
indemnifying a lender of the stock loan via the rider portion.

16. The method of claim 12, comprising:
configuring the stock loan as non-recourse to the insured.

17. The method of claim 12, comprising:
wherein the stock loan is non-callable.

18. The method of claim 12, comprising:
providing a right to liberate upside asset appreciation of stock associated with the stock loan, to the insured.

19. The method of claim 12, comprising:
defining the stock loan to comprise a fixed term loan having loan terms; and
guaranteeing the renewing the stock loan at an end of the term, at the loan terms.

20. The method of claim 12, wherein upon death of insured or sale of the life insurance policy, comprising:
paying the cumulative loan balance using the death benefit; and
redeeming the stock collateral.

21. A method for providing life insurance with no out-of-pocket cost comprising:
defining a life insurance policy having life insurance premiums; and
using stock collateral for a stock loan which is configured to pay the life insurance premiums.

22. The method of claim 21, wherein interest accrued on the stock loan is non-compounding.
